(19) United States
(12) Patent Application Publication
(10) Pub. No.: US 2023/0400832 A1
(43) Pub. Date: Dec. 14, 2023

(54) METHOD FOR RECORDING MASS PRODUCTION WORK CYCLES

(71) Applicant: AISEMO GMBH, Weibern (AT)

(72) Inventors: Wolfgang AUER, Weibern (AT); Werner SCHWARZ, Leonding (AT)

(73) Assignee: AISEMO GMBH, Weibern (AT)

(21) Appl. No.: 18/249,281

(22) PCT Filed: Oct. 14, 2021
(86) PCT No.: PCT/AT2021/000019

§ 371 Date: Apr. 17, 2023

(30) Foreign Application Priority Data
Oct. 15, 2020 (AT) A 234/2020

(51) Int. Cl. G05B 19/4065

(52) U.S. Cl. CPC G05B 19/4065; G05B 2219/37587; G05B 2219/45244

(57) ABSTRACT

A method for recording mass production work cycles of a facility. The facility having a machine and a replaceable mass production tool which is secured to the machine and is moved by the machine. According to the method, number sequences are formed that indicate how many cycles have been carried out by a specific tool in cooperation with a specific machine. The required detection of the cooperation of the particular tool with the particular machine is carried out on the basis of a comparison between the time curves of the values of two measured physical variables, wherein one physical variable is measured on the tool, and the second physical variable is measured on the machine, the two physical variables being such that the values thereof change cyclically with the rhythm of the work cycle carried out by the tool and the machine together.

The invention relates to a method for recording mass production work cycles of an installation, the installation comprising a machine and a replaceable mass production tool which is secured to the machine and is moved by the machine.

Installations in this sense may be, for example, injection-molding machines, die-casting machines, embossing machines, drop forging presses, folding machines, bending machines, punching installations etc.—complemented by the relevant mass production tool. In principle, this includes all installations which comprise a machine and a mass production tool and are used for mass producing products from a material by primary forming, reshaping or cutting by mechanical action, the mass production tool being formed in a suitable manner to produce the shape of the product to be formed and the machine being fitted with the mass production tool and driving the necessary movements of the mass production tool and/or the material to be processed.

The invention is described in greater detail below primarily using injection molding as an exemplary application, without limiting the invention to this. This application relates to a typical and valuable use of the invention.

For injection molding within the meaning of this document, a flowable mass is injected under high pressure into a mold cavity of a split injection mold—also referred to as an “injection-molding tool”, allowed to solidify there due to a change in temperature and then removed from the mold as a solid injection-molded part. In order to close and open the injection-molding tool, parts of the injection-molding tool that can be detached from one another are secured to different parts of an injection-molding machine that can be moved in a driven manner relative to one another and said parts of the injection-molding tool are moved toward one another and away from one another, that is to say between a closed and open state, by said parts of the injection-molding machine in time with the casting cycle, said parts of the injection-molding tool being pressed against one another under high compressive force in the closed state.

The casting cycles mean high stress primarily for the injection-molding tool, but also for the injection-molding machine, this leading to a need for servicing. In order to be able to readily initiate monitoring operations and servicing operations as required, the work of injection-molding tools and machines is monitored by sensors in several respects and also recorded at least to such an extent that it is possible to easily identify how many casting cycles have been carried out since the last servicing operation.

By way of example, EP 1486312 B1 and EP 1762360 B1 concern attaching counting units and associated sensors to injection-molding tools in order to be able to detect and also count injection-molding processes or opening and closing processes of the respective injection-molding tool.

EP 2 576179 B1 proposes attaching a sensor to an injection-molding tool and possibly also to the material feeding device of an injection-molding machine, the sensor continuously measuring mechanical vibrations at the attachment point, and examining these measurement results in respect of the frequency spectrum and time profile and subjecting them to pattern identification based thereon in order to be able to infer states of installation parts or material to be cast on the basis of identified patterns.

EP 2008413 B1 is concerned with establishing a wireless connection between an apparatus and a device for carrying out an operation depending on the distance between the apparatus and the device. According to one variant, when the apparatus and the device are sufficiently close to one another, the distance between them is measured, an acceleration profile is calculated therefrom and displayed and a check is made in respect of whether the display corresponds to a prescribed rule. In the positive case, the wireless connection is formed, this being understood to mean that, for example, a Bluetooth connection is established.

TW 201826183 A and U.S. Pat. No. 8,907,768 B2 describe a method for establishing a wireless communication channel between two mobile devices, such as typically smartphones, with the interconnection of a server for the purpose of carrying out transactions, such as typically counting in a digital manner. If a mobile device is shaken, it communicates to the server its geographical position and its readiness for connection to a further mobile device. Only if the same is performed at the same time by a second mobile device in a prescribed region of proximity to the first mobile device and also shaking characteristic values correspond are further steps carried out by the server in order to establish the communication channel between the two devices that is required for the intended transaction.

U.S. Ser. No. 10/034,124 B2 and WO 2010078094 A describe establishing a wireless connection, such as a Bluetooth connection for example, between two mobile devices, such as typically a smartphone and a mobile loudspeaker, by way of an identical measurable activity, such as joint shaking for example, which is measured by acceleration sensors, being carried out with both devices at the same time.

The invention is based on the object of improving automatic recording of work cycles of an installation consisting of a machine and a mass production tool to the effect that a better indication of those counting sequences which relate to the number of work cycles that the mass production tool has carried out can be achieved in a simple manner. By way of example and typically, the machine may be an injection-molding machine and the mass production tool may be an injection-molding tool.

Using the example of injection molding, the object is achieved according to the invention in that counting sequences that indicate how many cycles have been carried out with cooperation between a particular injection-molding tool and a particular injection-molding machine are formed, and in that the required detection of the cooperation between the respective injection-molding tool and the respective injection-molding machine is carried out on the basis of a comparison between the time profiles of the values of two measured physical variables, one physical variable being measured on the injection-molding tool and the second physical variable being measured on the injection-molding machine, and both physical variables being such that the values thereof change cyclically with the rhythm of the injection-molding cycle carried out by the tool and the machine together.

Since the counting sequences formed each relate to a pairing of an injection-molding tool and an injection-molding machine, it is possible by storing and combining the counting sequences and combination with notes in respect of servicing not only to identify how many cycles an injection-molding tool and an injection-molding machine have each carried out independently of one another but also, for example, whether an injection-molding tool requires servicing earlier or later when used on a particular injection-molding machine or, conversely, whether injection-molding machines require servicing earlier or later when a particular injection-molding tool is used.

Owing to said methods for identifying the cooperation between a respective injection-molding tool and a respective injection-molding machine, starting and ending the counting sequences in respect of pairings of injection-molding tools and injection-molding machines can be highly automated in a very simple manner such that it means as good as no additional work for the people working in production.

This invention will be illustrated with reference to a drawing.

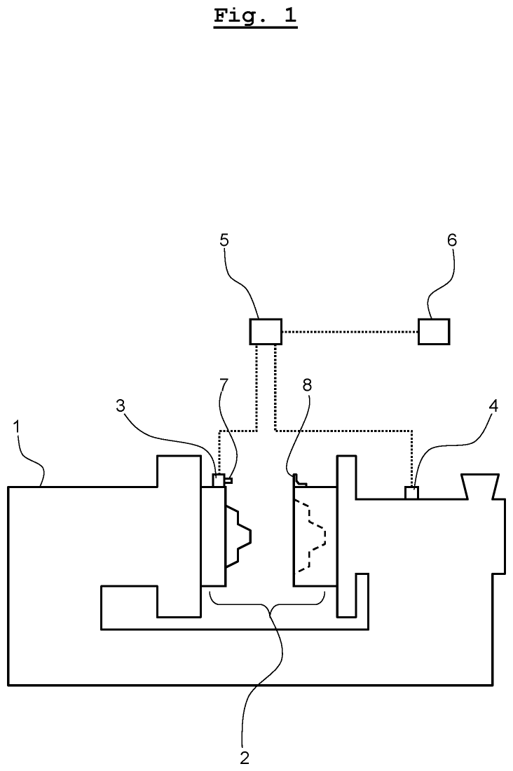

FIG. 1: shows, in the form of a block diagram, the essential components according to the invention in an exemplary architecture according to the invention. Data transmission paths, for example radio links, are represented by dash-dotted lines.

According to FIG. 1, a two-part injection-molding tool 2 is clamped onto an injection-molding machine 1. A machine-side sensor 3 is attached to the injection-molding machine 1 and a tool-side sensor 4 is attached to the injection-molding tool 2. In terms of electronic assemblies, a coupling unit 5 and a counting unit 6 are provided in addition to the sensors 3, 4.

The start-up and operation of the arrangement according to FIG. 1 can be split, for example, into the following successive steps.
The injection-molding tool 2, to which the tool-side sensor 4 is attached, is fitted to the injection-molding machine 1, to which the machine-side sensor 3 is attached, in the same way as a conventional injection-molding tool.
As in the case of conventional operation for injection molding, the injection-molding machine is also supplied with material to be cast (plastic granules or tool mass).
The sensors 3, 4, the coupling unit 5 and the counting unit 6 are switched on (if they are not permanently in a switched-on state in any case).
Injection-molding cycles are carried out, that is to say, at least after one start-up phase, the injection-molding tool 2 is routinely closed by the injection-molding machine 1, masses to be cast are pushed into the cavity of the injection-molding tool 2 and allowed to solidify by cooling down (or heating up in the case of thermosets) and then removed from the mold by way of the tool halves of the injection-molding tool 2 being moved apart and the cast part being ejected.

According to the invention, the sensors 3, 4, the coupling unit 5 and the counting unit 6 operate in the following way:
a The tool-side sensor 4 continuously and repeatedly measures the value of a physical state on the injection-molding tool 2, typically an acceleration (this also including vibrations), and sends this information, including identification information relating to itself, into the immediate surroundings in a continually updated manner in line with a defined radio protocol.
b The machine-side sensor 3 continuously and repeatedly measures the value of a physical state on the injection-molding machine 1, for example an acceleration (vibrations), a temperature, an operation-related electrical current, an operation-related electrical control voltage etc., and sends this information, including identification information relating to itself, into the immediate surroundings in a continually updated manner in line with a defined protocol.
c The coupling unit 5 continuously receives the signals from the sensors 3, 4 (and possibly also from further sensors on other injection-molding tools and injection-molding machines) and can correctly assign these individual signals to the respective individual sensors 3, 4 on the basis of the defined protocol, so that a value sequence that becomes longer over time and from which the time profile of the respective measured physical variable can be identified is assigned to each of the sensors 3, 4.
d The coupling unit 5 checks, using automatic pattern identification, in groups of two value sequences in accordance with the previous point, one of which originates from a machine-side sensor 3 and one of which originates from a tool-side sensor 4, whether these two value sequences have features which repeatedly run synchronously in relation to one another in respect of time. If so, this is used as an indication that the injection-molding tool 2 belonging to the tool-side sensor 4 is fitted on the injection-molding machine 1 belonging to the machine-side sensor 3.

The features which run synchronously in respect of time can mean, for example, simultaneous shaking peaks which are determined by acceleration measurement and which occur when an injection-molding tool is clamped to an injection-molding machine or when a (newly fitted) injection-molding tool on an injection-molding machine is closed (for the first time on a trial basis). Features which repeatedly run synchronously in relation to one another in respect of time are also provided, for example, when the time profile of the physical variable measured on the injection-molding machine is periodically repeated and the same also applies to the time profile of the physical variable measured on the injection-molding tool if, in addition, the period duration for the two measured physical variables is the same, that is to say they both have the same cycle time or repetition frequency.
e In respect of each pairing, identified in accordance with point d, comprising an injection-molding machine and an injection-molding tool, continuous attempts are made by continuous analysis of the time profile of at least one of the measured physical variables to identify a repetition cycle for the time profile of this physical variable. In the positive case, this cycle is classified as a common work cycle for the injection-molding machine and the injection-molding tool.
f A counting pulse is sent to the counting unit 6 for each work cycle, classified by the coupling unit 5, of an identified pair comprising an injection-molding machine 1 and an injection-molding tool 2, the counting pulse containing the (digital) information that the pair formed from the respective injection-molding machine 1 and the respective injection-molding tool 2 has carried out a further injection-molding cycle.
g The counting unit 6 creates a dedicated counting sequence for each communicated pairing comprising an injection-molding machine 1 and an injection-molding tool 2 in each case and increments the count value by one with each counting pulse that is suitable for the pairing and arrives from the coupling unit 5.

The prior art already contains a variety of possible mathematical methods for the tasks according to points d and e. According to one exemplary method, a fast Fourier transform (“FFT”) is carried out for each of the value sequences associated with the individual sensors 3, 4 and therefore the frequency components of the value sequence are determined. If two value sequences have the same fundamental frequency here, this is a strong indication that they belong to a pair comprising an injection-molding machine 1 and an injection-molding tool 2 fitted precisely on the injection-molding machine.

An easily checkable, very strong indication of said association is also provided, for example, when brief vibrations with comparatively high, at least sometimes precisely the same frequencies are repeatedly determined.

Limiting boundary conditions can be incorporated into the selection of the combinations of two value sequences that are to be checked for synchronicity according to point d. For example, an injection-molding tool 2, which was identified as being currently clearly fitted to a first injection-molding machine 1, cannot be fitted to a further injection-molding machine at the same time, for which reason the pairing with the further injection-molding machine does not have to be additionally checked by the relatively data-intensive pattern identification at least at the current time.

If after the end of a production series the injection-molding tool 2 is separated from the injection-molding machine 1 again, no common injection-molding cycles by the injection-molding tool 2 and the injection-molding machine 1 are identified by the coupling unit 5 and therefore no further counting pulses in this respect are sent to the counting unit 6 either.

Depending on how many injection-molding machines 1 and injection-molding tools 2 are combined in a common cycle counting system according to the invention, it may be more expedient to design coupling units 5, counting units 6 and machine-side sensors 3 as respectively separate structural units. In this case, for example, a coupling unit 5 can monitor a plurality of machine-side sensors 3 and tool-side sensors 4, and a plurality of such coupling units 5 can supply counting pulses to a common counting unit 6.

However, in a very simple but economically very expedient case, a machine-side sensor 3, a coupling unit 5 and a counting unit 6 can also be combined in one assembly, which is fitted on an injection-molding machine 1, and communicate with those tool-side sensors which are located in the region of proximity and are switched on, common injection-molding cycles with the injection-molding machine 1 being determined only for that tool-side sensor 4 which is fitted to the injection-molding tool 2 fitted injection-molding machine 1.

The electronic assemblies sensors 3, 4, coupling unit 5 and a counting unit 6 are permanently in the switched-on state, the people involved in production using the injection-molding machines 1 and injection-molding tools 2 do not need to carry out any separate work for detecting the counting cycles according to the invention. They can routinely work just as they would when working with injection-molding installations on which there are no counting apparatuses and on which counting is simply not performed.

In the case of the electronic assemblies machine-side sensor 3, coupling unit 5 and counting unit 6, it is easy to permanently supply them with energy and therefore be able to allow them to be permanently switched on since these assemblies can be easily secured to permanently locally immovable parts of an installation or building.

This is not the case with the tool-side sensor 4 which is fitted to an injection-molding tool 2 which is fitted only temporarily to one of several possible injection-molding machines 1 and is moved by it, and often also only lies in a storage rack for a long time (days, months, if not years). It is therefore worth equipping the tool-side sensor 4 with a storage device for electrical energy (electrical rechargeable battery or electrical capacitor) and an apparatus for obtaining electrical energy, which apparatus comes into operation when the tool-side sensor 4 is moved, and then charges an electrical energy store with electrical energy. Therefore, power can be supplied to the tool-side sensor 4 from the storage apparatus for electrical energy precisely when it is required, without the tool-side sensor 4 having to be connected to any further power supply system for this purpose.

Said apparatus for obtaining electrical energy is typically a generator, that is to say a machine which converts energy from mechanical motion into electrical energy. By way of example, the mechanical energy can be obtained from the relative movement between two parts if the two parts are held against one another such that they can be moved in a guided manner and are moved by vibration; either the piezoelectric effect or the electrodynamics effect (change in the magnetic field acting on a line coil with respect to time) can be utilized here. Primarily when the tool is a casting mold in the case of which the temperature changes with each cycle, that is to say is an injection-molding tool 2 for example, the Peltier effect, according to which an electrical current flow can be driven due to temperature differences, can also be used as the effect for supplying power to the tool-side sensor 4.

FIG. 1 indicates that the tool-side sensor 4 is equipped with a slide 7 which is movable relative to the housing of the tool-side sensor 4 and, when the injection-molding tool 2 is closed, butts against a stop part 8 and as a result is moved in relation the housing of the tool-side sensor 4. To this end, the stop part 8 is secured to that half of the injection-molding tool 2 to which the tool-side sensor 4 is not secured. The relative movement of the slide 7, which movement is driven by the injection-molding machine 1, in relation to the housing of the tool-side sensor 4 is the mechanical energy input for an electrodynamics linear generator, in the case of which the slide 7 is one of the required parts that are movable relative to one another and the second required part is rigidly connected to the housing of the tool-side sensor 4.

If the injection-molding tool 2 with the tool-side sensor 4 equipped in this way is in storage for a relatively long time, the tool-side sensor 4 will cease measuring and sending at some point since the energy required therefor is lacking. At the latest when the injection-molding tool 2 is fitted to an injection-molding machine 1 and injection-molding cycles are carried out, the tool-side sensor 4 is also supplied with energy by the movement of the injection-molding tool 2 taking place with the cycles, as a result of which the sensor starts the measurement and sending operations required according to the invention precisely when they are required.

An electrical voltage or an electrical current, which electrical voltage or electrical current is generated by the described manner of obtaining energy, can also serve as that physical variable which is measured by the tool-side sensor 4 and the magnitude of which is communicated to the coupling unit 5 and the time profile of which serves there for the further described information processing.

The physical variables that are measured by the sensors 3, 4 may be for example: accelerations (these also including vibrations), angular positions, speeds, temperatures, electrical currents or voltages or field strengths, physical distances from reference points, elastic deformations, magnetic field variables, forces, concentrations of substance fractions in gases or liquids etc.

1. A method for recording mass production work cycles of an installation, the installation comprising a machine and a replaceable mass production tool which is secured to the machine and is moved by the machine,
wherein
counting sequences that indicate how many cycles have been carried out with cooperation between a particular mass production tool and a particular machine are formed, and in that the required detection of the cooperation between the respective mass production tool and the respective machine is carried out on the basis of a comparison between the time profiles of the values of two measured physical variables, one physical variable being measured on the tool and the second physical variable being measured on the machine, and both physical variables being such that the value thereof changes cyclically with the rhythm of the work cycle carried out by the tool and the machine together.

2. The method as claimed in claim 1, wherein
a a tool-side sensor attached to the tool continuously and repeatedly measures the value of a physical state on the tool, and sends this information, including identification information relating to itself, to a coupling unit in a continually updated manner,
b a machine-side sensor attached to the machine continuously and repeatedly measures the value of a physical state on the machine, the value fluctuating cyclically with the work cycles, and transmits this information, including identification information relating to itself, to the coupling unit in a continually updated manner,
c the coupling unit forms, from the signals received from the tool-side sensors and machine-side sensors, value sequences associated with the individual sensors (4, 3), the value sequences each representing information about the respective time profile of the physical variables measured by the respective sensors,
d the coupling unit checks, in groups of two value sequences, one of which originates from a machine-side sensor and one of which originates from a tool-side sensor, whether these two value sequences have features which repeatedly run synchronously in relation to one another in respect of time and, in the positive case, uses this as an indication that the injection-molding tool belonging to the tool-side sensor is fitted on the machine belonging to the machine-side sensor,
e the coupling unit extracts, from the value sequences of pairs comprising a machine and a tool that are identified as being associated, a characteristic value for the cyclical course of the work cycles forming the basis, it being possible to distinguish successive work cycles from one another using the characteristic value, and identifies the individual work cycles therefrom,
f the coupling unit transmits a counting pulse to a counting unit for each identified work cycle of an identified pair comprising a machine and a tool, the counting pulse containing the information that the pair formed from the respective machine and the respective tool has carried out a further work cycle, and
g that the counting unit creates a dedicated counting sequence for each communicated pairing comprising a machine and a tool in each case and increments the count value by one with each counting pulse that is suitable for the pairing and arrives from the coupling unit.

3. The method as claimed in claim 1, wherein the physical variable measured on the tool and the machine is an acceleration in each case.

4. The method as claimed in claim 1, wherein the physical variable measured on the machine is an electrical voltage or an electrical current which triggers a function of the machine.

5. The method as claimed in claim 1, wherein the tool-side sensor is supplied with electrical energy by energy harvesting.

6. The method as claimed in claim 5, wherein electrical energy is obtained from mechanical energy and/or from temperature differences.

7. The method as claimed in claim 1, wherein the machine is a casting machine, and in that the tool is a casting mold.

8. The method as claimed in claim 7, wherein the casting machine is an injection-molding machine, and in that the tool is an injection-molding tool.

9. The method as claimed in claim 1, wherein the machine is a bending or punching or punching-and-bending or embossing or forging machine, and in that the tool is a bending or punching or punching-and-bending or embossing or forging tool.
